(19) United States
(12) Patent Application Publication
(10) Pub. No.: US 2023/0312182 A1
(43) Pub. Date: Oct. 5, 2023

(54) SMART FOOD DELIVERY BAG

(71) Applicant: Candi R. Watts, Miami, FL (US)

(72) Inventor: Candi R. Watts, Miami, FL (US)

(21) Appl. No.: 17/712,143

(22) Filed: Apr. 2, 2022

(51) Int. Cl. B65D 30/22; B65D 33/00; B65D 33/10; B65D 33/16

(52) U.S. Cl. CPC B65D 31/12; B65D 33/004; B65D 33/105; B65D 33/16

(57) ABSTRACT

A food delivery bag may have a bag for delivering food and beverages is presented. The bag may comprise a front panel, a rear panel, a left side panel, a right side panel, and a bottom panel. The front panel, the rear panel, and the bottom panel may be corrugated such that the bag may collapse for storage by accordion-folding the front panel, the rear panel, and the bottom panel. The top of the bag may be open.

### FIELD OF THE INVENTION

This invention relates to food delivery. More particularly, it relates to a smart bag to prevent unauthorized access to food being delivered to a customer.

### BACKGROUND

A paper bag is a bag made of paper, usually kraft paper. Paper bags can be made either with virgin or recycled fibers to meet customers' demands. Paper bags are commonly used as shopping carrier bags and for packaging of some consumer goods. They carry a wide range of products from groceries, glass bottles, clothing, books, toiletries, electronics, and various other goods and can also function as means of transport in day-to-day activities.

Plastic bags were introduced in the 1970s, and thanks to their lower cost, eventually replaced paper bags as the bag of choice for grocery stores. With the trend towards phasing out lightweight plastic bags, though, some grocers and shoppers have switched back to paper bags.

Standard brown paper bags are made from kraft paper. Tote-style paper carrier bags, such as those often used by department stores or as gift bags, can be made from any kind of paper, and come in any color. There are two different styles of handles for paper carrier bags: flat handles and cord handles. Paper carrier bags made from virgin kraft paper are developed especially for demanding packaging. Paper bags can be made from recycled paper, with some local laws requiring bags to have a minimum percentage of post-consumer recycled content.

Paper shopping bags, brown paper bags, grocery bags, paper bread bags and other light duty bags have a single layer of paper. A variety of constructions and designs are available. Many are printed with the names of stores and brands. Paper bags are not waterproof. Types of paper bag are: laminated, twisted, flat tap. The laminated bag, whilst not totally waterproof, has a laminate that protects the outside to some degree.

With all the possible packaging available there is no smart type of bag available to keep food or the contents of the bag secure and to prevent tampering upon delivery. Contactless delivery is of upmost importance in today's society.

Accordingly, and in light of the foregoing, it would be desirable to have a smart package for example, a bag, that would secure the contents of the bag containing food and/or drink(s) and prevent tampering of this contents. It would also be advantageous to have cup holders associated with the packaging to aid in delivery and to keep spills from occurring.

### DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is an isometric view of a bag 200, according to an embodiment of the present invention;

FIG. 2 is a front view of a bag 200, according to an embodiment of the present invention;

FIG. 3 is a left side view of a bag 200, according to an embodiment of the present invention;

FIG. 4 is a top view of a bag 200, according to an embodiment of the present invention;

FIG. 5 is an isometric view of a bag 200, according to an embodiment of the present invention illustrating the sequence of collapsing the bag 200;

FIG. 6 is a front view of a bag 200 with a lid 270 according to an embodiment of the present invention;

FIG. 7 is an isometric view of a bag 200 with a lid 270, according to an embodiment of the present invention;

FIG. 8 is an in-use view of a bag 200, according to an embodiment of the present invention; and,

FIG. 9 is a block diagram illustrating the flow through a restaurant according to an embodiment of the present invention.

### DESCRIPTIVE KEY

100 food delivery bag
200 bag
202 front panel
204 rear panel
206 left side panel
208 right side panel
210 bottom panel
212 first cup carrier
214 second cup carrier
220 cup carrier top
222 first top portion
224 second top portion
226 hinge line
230 first cup aperture
232 second cup aperture
240 cup carrier brace
242 first cutout
244 second cutout
250 handle
260 tracking chip
270 lid
272 lid hinge
274 lid lock
280 fully expanded bag
282 partially collapsed bag
284 fully collapsed bag
900 food container
902 beverage cup
904 supply of bags
906 empty bag
908 filled bag
920 order-taking point of sale terminal
922 order-taking chip scanner
930 order-track server
940 order-filling point of sale terminal
942 order-filling chip scanner
950 driver smart device
952 driver chip scanner
956 driver's vehicle
960 data network
962 cell phone networks
970 wirelessly scan

### DESCRIPTION OF THE INVENTION

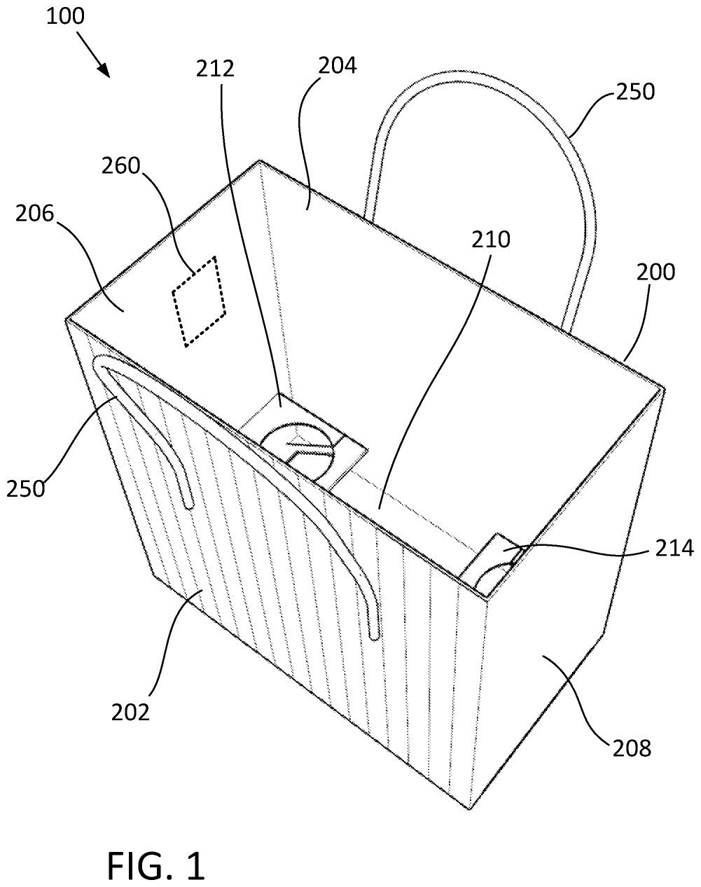

Referring to FIG. 1, the food delivery bag 100 (hereinafter invention) may comprise a bag 200 for delivering food and beverages. The bag 200 may comprise a front panel 202, a rear panel 204, a left side panel 206, a right side panel 208, and a bottom panel 210. The front panel 202, the rear panel 204, and the bottom panel 210 may be corrugated such that the bag 200 may collapse for storage by accordion-folding the front panel 202, the rear panel 204, and the bottom panel 210. The top of the bag 200 may be open.

The bag 200 may further comprise a first cup carrier 212 and a second cup carrier 214. In a preferred embodiment, the first cup carrier 212 and the second cup carrier 214 may each retain two (2) beverage cups in an upright orientation with the first cup carrier 212 coupled to the left side panel 206 and the second cup carrier 214 coupled to the right side panel 208. The first cup carrier 212 and the second cup carrier 214 may each fold when the bag 200 is collapsed such that the first cup carrier 212 and the second cup carrier 214 may reside within the folded bag.

The bag 200 may comprise a tracking chip 260. The tracking chip 260 may hold a unique identifier that uniquely identifies the bag 200. The tracking chip 260 may be read wirelessly using scanning hardware. As non-limiting examples, the tracking chip 260 may utilize RFID technology, NFC technology, Bluetooth® (including BLE) technology, or any combination thereof. The unique identifier may be operable to associate the bag 200 with a delivery order and with a metadata regarding the delivery order. As non-limiting examples, the metadata may comprise the contents of the delivery order, an order tracking number, the time that the delivery order was received, the name of a customer, a customer's address, the unique identifier of the bag 200, special delivery instructions, or any combination thereof.

The bag 200 may further comprise a pair of handles 250. The pair of handles 250 may be coupled to the front panel 202 and the rear panel 204 such that the pair of handles 250 to not interfere with the ability to collapse the bag 200.

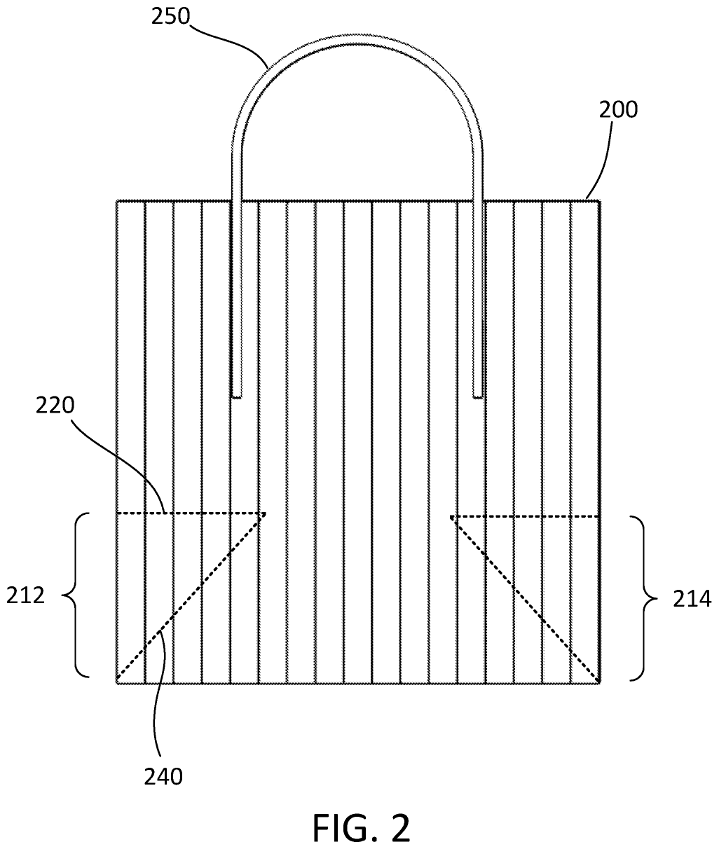

Turning now to FIG. 2, the front of the bag 200 is illustrated to show the positioning of the first cup carrier 212, the second cup carrier 214, and the pair of handles 250. An individual cup carrier selected from the first cup carrier 212 and the second cup carrier 214 may comprise a cup carrier top 220 and a cup carrier brace 240. The proximal end of the cup carrier top 220 may be pivotably coupled to a side panel. The bottom of the cup carrier brace 240 may be pivotably coupled to the same side panel at the bottom of the side panel. The top of the cup carrier brace 240 may be pivotably coupled to the distal and of the cup carrier top 220. The cup carrier top 220 may fold such that the individual cup carrier may be stowed by pivoting the cup carrier brace 240 upwards and folding the cup carrier top 220 against the side panel.

The lower ends of the pair of handles 250 may be coupled to the bag 200 and the center loop of the pair of handles 250 may extend above the bag 200 such that the pair of handles 250 may be grasped to carry the bag 200.

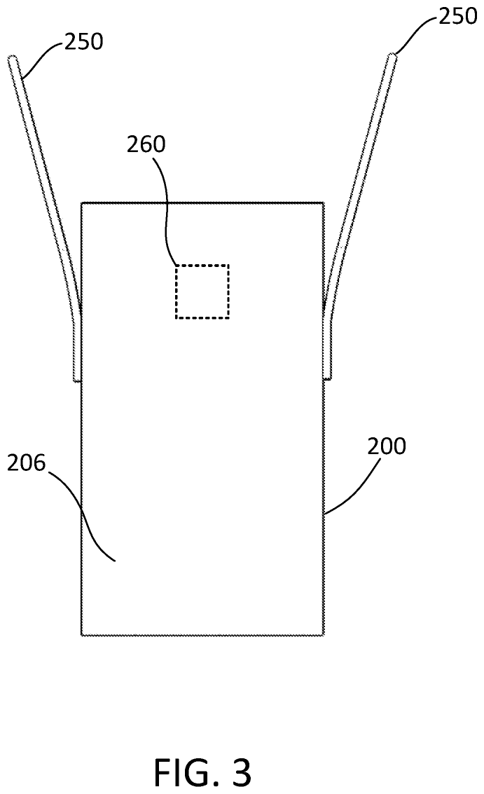

Turning now to FIG. 3, the left side of the bag 200 is illustrated. As a non-limiting example, the tracking chip 260 may be imbedded within the left side panel 206 of the bag 200 since the tracking chip 260 may be accessed wirelessly and no direct contact with the tracking chip 260 is necessary. The pair of handles 250 may be flexible. The pair of handles 250 may be oriented away from the top of the bag 200 to access the contents of the bag 200. The pair of handles 250 may be oriented towards the center of the bag 200 when carrying the bag 200. In some embodiments, the loops of the pair of handles 250 may be directed into the bags 200 during storage of the bag 200.

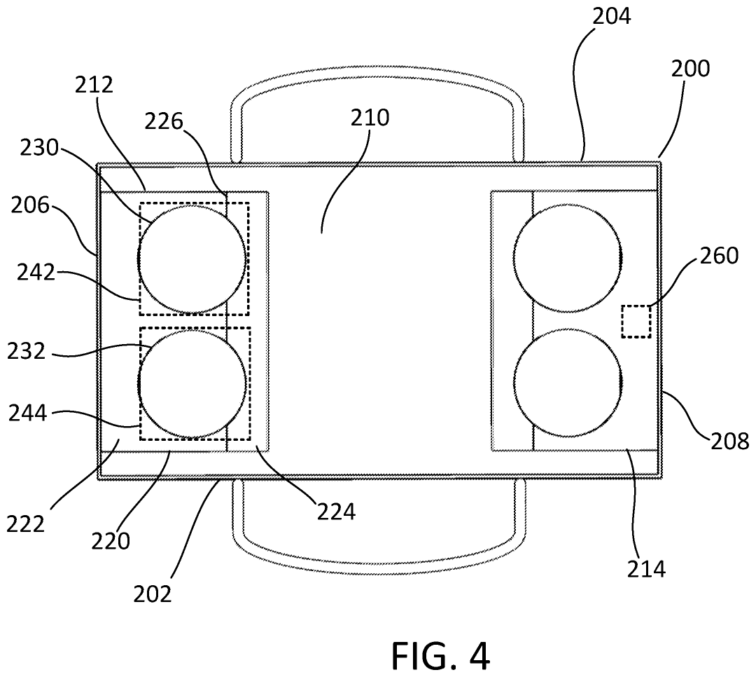

Turning now to FIG. 4, the figure illustrates the view when looking down at the top of the bag 200. The front panel 202, the rear panel 204, the left side panel 206, the right side panel 208 and the bottom panel 210 of the bag 200 define the boundaries of the bag 200. The first cup carrier 212 may be seen on the left side of the bag 200 and the second cup carrier 214 may be seen on the right side of the bag 200. Food containers may be placed into the bag 200 in the area between the first cup carrier 212 and the second cup carrier 214.

The cup carrier top 220 may comprise a first top portion 222 and a second top portion 224. The first top portion 222 and the second top portion 224 may fold at a hinge line 226 when the individual cup carrier is stowed against the side of the bag 200.

In a preferred embodiment, the individual cup carrier may comprise a first cup aperture 230 and a second cup aperture 232 such that the individual cup carrier may retain one (1) or two (2) beverage cups. The first cup carrier 212 and the second cup carrier 214 may be used simultaneously or individually. The first cup carrier 212 or the second cup carrier 214 may be folded against the side panel to free up space in the bag 200 for food items when only one (1) cup carrier is needed for beverages and more space is needed for food containers.

The cup carrier brace, located beneath the cup carrier top 220 and therefore not visible in FIG. 4, may comprise a first cutout 242 and a second cutout 244. The first cutout 242 may be located directly under the first cup aperture 230 and the second cutout 244 may be located directly under the second cup aperture 232. The first cutout 242 and the second cutout 244 may be operable to allow beverage cups placed into the first cup aperture 230 and the second cup aperture 232 to rest on the bottom panel 210.

The tracking chip 260 may be imbedded into any portion of the bag 200 where the tracking chip 260 will not interfere with collapsing the bag 200. As a non-limiting example of an alternative location for the tracking chip 260, the tracking chip 260 may be imbedded in or coupled to the bottom of the individual cup carrier.

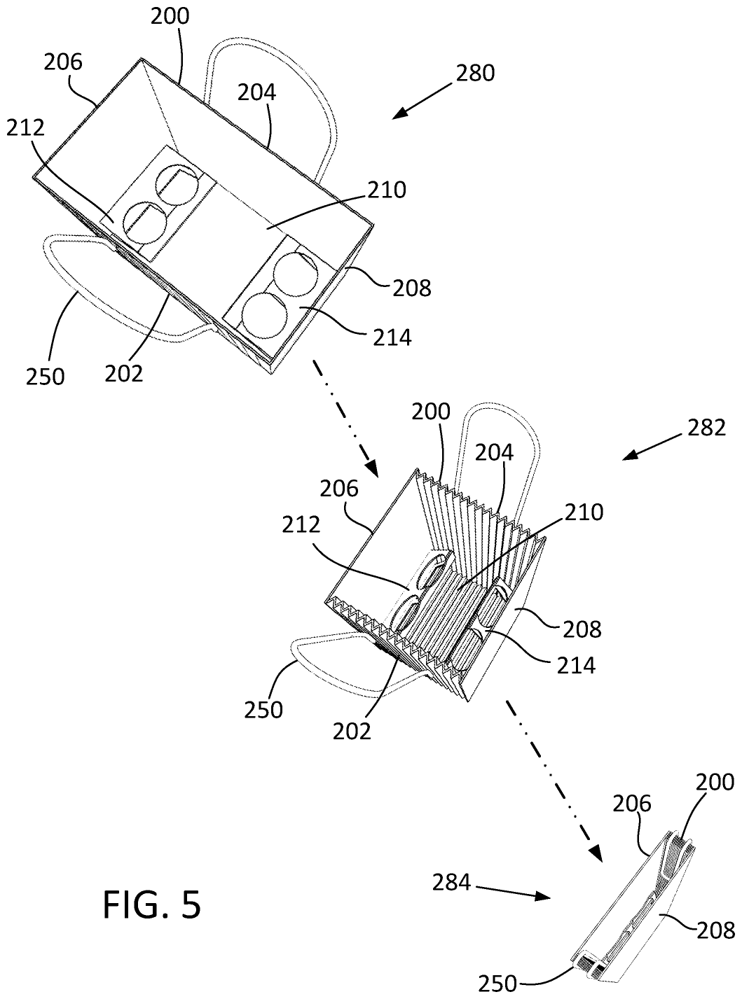

Turning now to FIG. 5, the figure illustrates the sequence of collapsing the bag 200 for storage. Starting with a fully expanded bag 280, the left side panel 206 and the right side panel 208 are pushed towards each other such that the front panel 202, the rear panel 204, and the bottom panel 210 begin to accordion-fold. Simultaneously, the first cup carrier 212 and the second cup carrier 214 may begin to fold against side panels. A partially collapsed bag 282 may have the same front-to-rear depth however the side-to-side width may be reduced. The pair of handles 250 may be pushed into the bag 200 before the bag 200 becomes a fully collapsed bag 284 which may be ready for storing.

To expand the bag 200 for use, the sequence may be reversed by pulling the left side panel 206 and the right side panel 208 apart and unfolding the first cup carrier 212 and the second cup carrier 214.

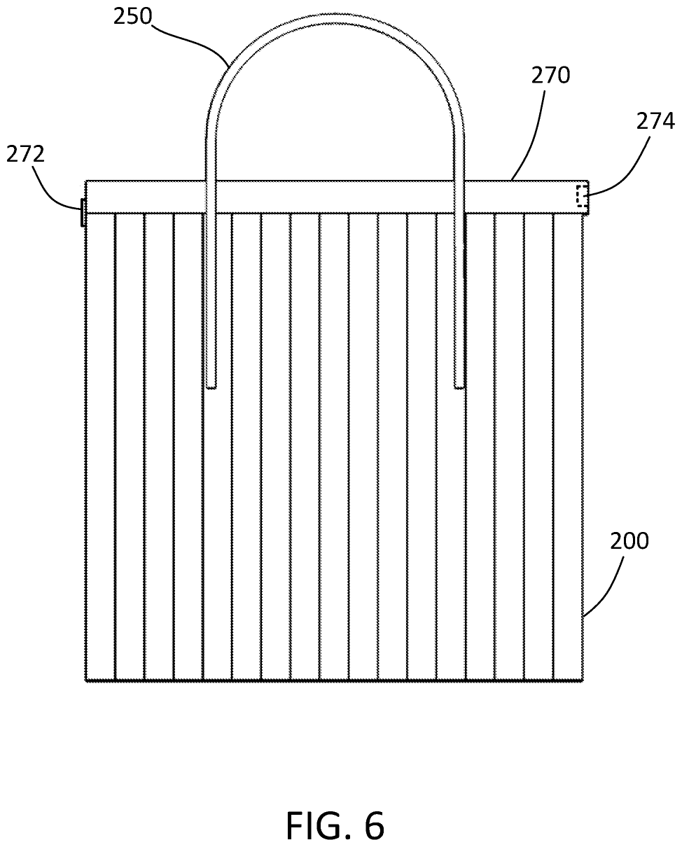

Turning now to FIG. 6, the bag 200 may comprise a lid 270. The lid 270 may be hingedly coupled to the bag 200 via a lid hinge 272. The lid 270 may be operable to block access to the contents of the bag 200 when the lid 270 is covering the bag 200. A locked lid may assure that the delivery driver does not consume or tamper with the contents of the bag 200. The lid 270 may be flipped back and allowed to hang parallel to the side of the bag 200 while accessing contents of the bag 200. In some embodiments, the bag 200 and the lid 270 may comprise a lid lock 274. The lid lock 274 may be located on the side of the bag 200 opposite the lid hinge 272 such that the lid hinge 272 and the lid lock 274 may prevent removal of the lid 270 when the lid lock 274 is locked. As a non-limiting example, the lid lock 274 may be a battery-powered device that binds the lid 270 to the side panel of the bag 200 when locked and releases the lid 270 from the side panel when unlocked. The lid lock 274 may communicate wirelessly with an external device which may command the lid lock 274 to lock and to unlock.

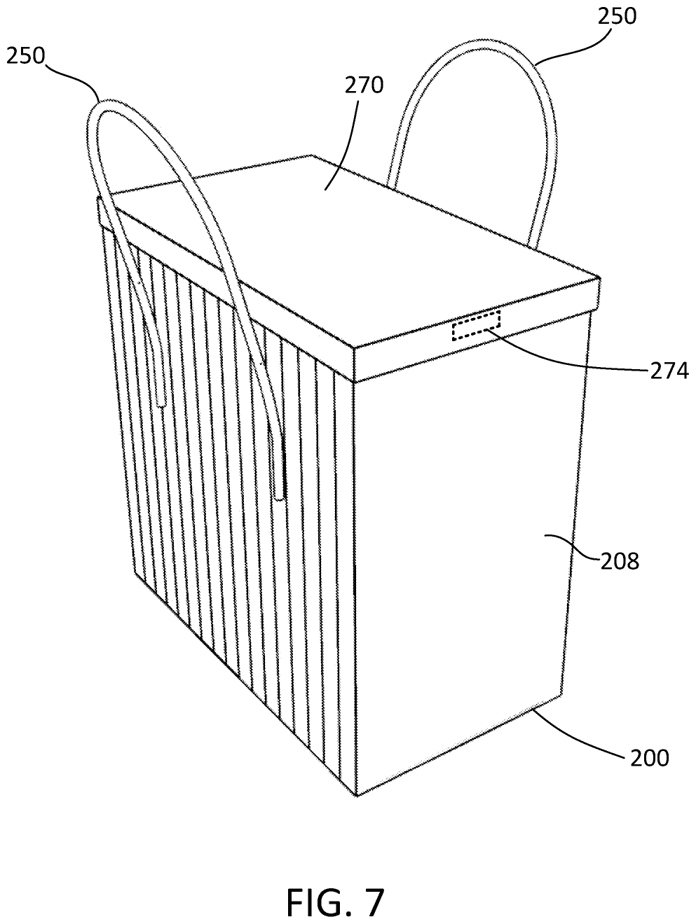

Turning now to FIG. 7, an isometric view of the bag 200 with the lid 270 is shown. The pair of handles 250 may be coupled to the front and rear of the bag 200 such that the pair of handles 250 do not interfere with operation of the lid 270. In the embodiment illustrated, the position of the lid lock 274 may be seen on the right-side panel 208.

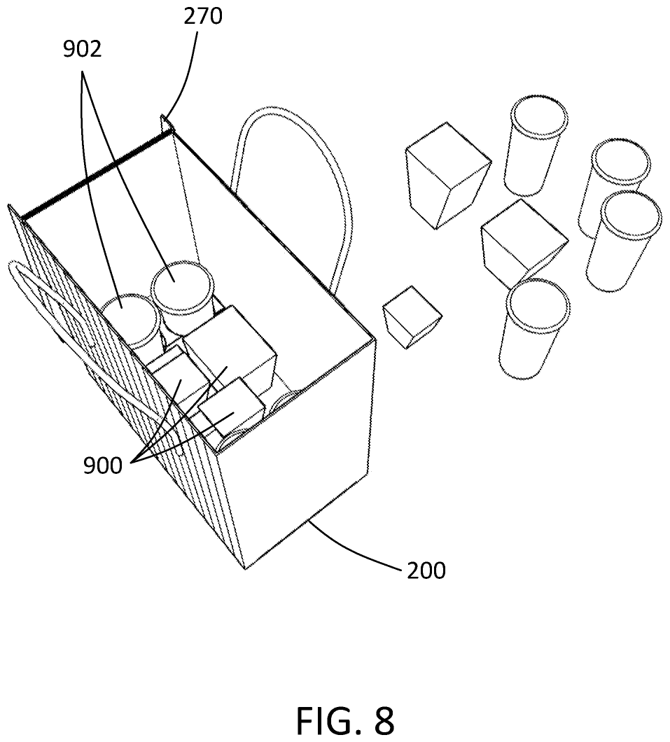

Turning now to FIG. 8, the figure illustrates one (1) or more food containers 900 and one (1) or more beverage cups 902 in the bag 200. The one (1) or more beverage cups 902 may be placed into cup carriers on either or both sides of the bag 200 and the one (1) nor more food containers 900 may be placed into the center of the bag 200. The lid 270 is open and suspended along the side of the bag 200.

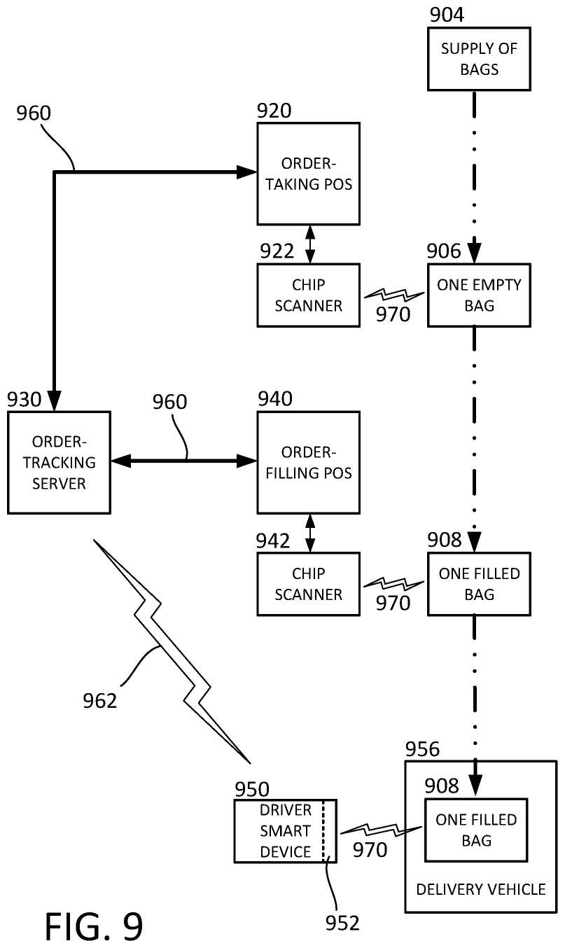

Turning now to FIG. 9, the figure illustrates the flow within a restaurant that uses the bags. The delivery order may be received at an order-taking point of sale terminal 920 that is executing an order-taking software application. As a non-limiting example, the delivery order may be received by phone. An order-taker may enter details of the delivery order into the order-taking point of sale terminal 920 and may select an empty bag 906 from a supply of bags 904. The order-taker may wirelessly scan 970 the empty bag 906 using an order-taking chip scanner 922 to read the unique identifier from the tracking chip in the empty bag 906. The order-taking point of sale terminal 920 may associate the unique identifier with the delivery order.

The order-taking point of sale terminal 920 may communicate the delivery order and the metadata regarding the delivery order to an order-track server 930 via one (1) or more data networks 960. The order-track server 930 may be executing an order-tracking software application. As non-limiting examples, the metadata may comprise the contents of the delivery order, an order tracking number, the time that the delivery order was received, the name of the customer, the customer's address, the unique identifier of the empty bag 906, special delivery instructions, or any combination thereof.

The empty bag 906 may be passed to an order-filler. The order-filler may have access to an order-filling point of sale terminal 940 that is executing an order-filling software application. The order-filler may wirelessly scan 970 the empty bag 906 using an order-filling chip scanner 942 coupled to the order-filling point of sale terminal 940 to acquire the unique identifier of the empty bag 906. The order-filling point of sale terminal 940 may recall the delivery order and the metadata from the order-track server 930 over the one or more data networks 960 based upon the unique identifier. Using a displayed copy of the delivery order, the order-filler may place the food and beverages into the empty bag 906 to fulfill the delivery order, thus converting the empty bag 906 into a filled bag 908. The order-filler may update the status of the delivery order as stored at the order-track server 930 using the order-filling point of sale terminal 940. The updated status may indicate that the delivery order is filled and ready for delivery. If the filled bag 908 is equipped with a lid and a lid lock, the order-filler may close the lid and may activate the lid lock. The order-filler may pass the filled bag 908 to an area within the restaurant where a delivery driver may find the filled bag 908.

In some embodiments, the order-taking point of sale terminal 920, the order-filling point of sale terminal 940, the order-track server 930, or any combination thereof may be a single device with shared functions. The order-taking chip scanner 922 and the order-filling chip scanner 942 may also be a single device serving dual purposes.

In some embodiments, the order-track server 930 may track the delivery orders for a single restaurant, a local group of restaurants, a regional group of restaurants, a national group of restaurants, or any combination thereof.

The filled bag 908 may transferred to a driver's vehicle 956. The delivery driver may wirelessly scan 970 the filled bag 908 using a driver chip scanner 952 that is integrated into a driver smart device 950 to learn the unique identifier of the filled bag 908. The driver smart device 950 may communicate with the order-track server 930 via cell phone networks 962 to acquire the specifics of the delivery order and the metadata for the filled bag 908 based upon the unique identifier. The metadata may comprise the customer's address.

The driver smart device 950 may acquire data from a map database via the cell phone networks 962 and may compute a route from the driver's present location to the customer's address. The driver smart device 950 may then provide the delivery driver with turn by turn directions to reach the customer's address. The directions may be presented by the driver smart device 950 audibly and/or visually. The driver smart device 950 may determine when the delivery driver misses a turn or makes an incorrect turn and may alert the delivery driver using alert sounds and/or alert visual presentations. Upon reaching the customer's address, the driver smart device 950 may communicate wirelessly with the lid lock to unlock the lid of the filled bag 908 such that the contents of the filled bag 908 may be delivered to the customer.

The exact specifications, materials used, and method of use of the invention 100 may vary upon manufacturing. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A food delivery bag for protection of food and beverages being delivered to a customer, the food bag comprising:
a top, a front panel, a rear panel, a left side panel, a right-side panel, and a bottom panel;
a tracking chip, the tracking chip has a unique identifier that uniquely identifies the bag, the tracking chip has wireless technology for using scanning hardware; and
two handles, the first of the two handles coupled to an outside of the left side panel and the second of the two handles coupled to an outside of the right side panel.

2. The food bag according to claim 1, wherein the front panel, the rear panel and the bottom are corrugated.

3. The food bag according to claim 2, wherein the food bag is collapsible when empty.

4. The food bag according to claim 1, wherein the top is open.

5. The food bag according to claim 1, wherein the food bag further comprises a first cup carrier and a second cup carrier, wherein the first cup carrier and the second cup carrier being coupled to the right-side panel.

6. The food bag according to claim 1, wherein each of the first cup carrier and the second cup carrier retain two cups.

7. The food bag according to claim 1, wherein the wireless technology is RFID technology.

8. The food bag according to claim 1, wherein the wireless technology is NFC technology.

9. The food bag according to claim 1, wherein the wireless technology IEEE 802.16 (Bluetooth®).

10. The food bag according to claim 1, wherein the unique identifier has metadata regarding the delivery order.

11. The food bag according to claim 10, wherein the metadata having at least one of: contents of the delivery order, an order tracking number, the time that the delivery order was received, the name of a customer, a customer's address, the unique identifier of the bag, and special delivery instructions.

12. The food bag according to claim 1, wherein each of the cup carriers comprises a cup carrier top and a cup carrier brace.

13. The food bag according to claim 12, wherein each of the cup carriers having a proximal end, the proximal end of the cup carrier top is pivotably coupled to a side panel.

14. The food bag according to claim 12, wherein a bottom of the cup carrier brace is pivotably coupled to the same side panel at the bottom of the side panel.

15. The food bag according to claim 12, wherein the cup carrier top is foldable, wherein the foldable cup carrier top is configured that the individual cup carrier may be stowed by pivoting the cup carrier brace upwards and folding the cup carrier top against the side panel.

16. The food bag according to claim 12, wherein the cup carrier brace is not visible.

17. The food bag according to claim 12, wherein the cup carrier brace has a first cutout and a second cutout.

18. The food bag according to claim 17, wherein the first cutout is operable to allow beverage cups placed into a first cup aperture.

19. The food bag according to claim 17, wherein the second cutout is operable to allow beverage cups placed into a second cup aperture.

20. The food bag according to claim 1, wherein the food bag further comprises a locked lid, wherein the lid lock is located on the side of the bag opposite a lid hinge, wherein the lid hinge and the lid lock are configured to prevent removal of a lid when the lid lock is locked.
